(19) United States
(12) Patent Application Publication
(10) Pub. No.: US 2013/0221613 A1
(43) Pub. Date: Aug. 29, 2013

(54) PAPER SHEET CONVEYANCE DEVICE FOR CONVEYING PAPER SHEET TO IMAGE FORMING SECTION AND IMAGE FORMING APPARATUS HAVING PAPER SHEET CONVEYANCE DEVICE FOR CONVEYING PAPER SHEET TO IMAGE FORMING SECTION

(71) Applicant: Masato KOIKE, Sagamihara-shi (JP)

(72) Inventor: Masato KOIKE, Sagamihara-shi (JP)

(73) Assignee: KONICA MINOLTA BUSINESS TECHNOLOGIES, INC., Tokyo (JP)

(21) Appl. No.: 13/857,641

(22) Filed: Apr. 5, 2013

Related U.S. Application Data
(62) Division of application No. 13/288,178, filed on Nov. 3, 2011.

(30) Foreign Application Priority Data
Nov. 17, 2010 (JP) 2010-256964

(51) Int. Cl. B41J 13/03

(52) U.S. Cl. CPC B41J 13/03
USPC 271/272

(57) ABSTRACT

A paper sheet conveyance device for conveying a paper sheet to an image forming apparatus includes a corrugation roller for imparting corrugation onto both the left and right sides of a paper sheet, onto which an image has not been formed, with respect to a conveyance direction, by forming a curved portion along the conveyance direction.

This application is based on Japanese Patent Application No. 2010-256964 filed on Nov. 17, 2010 with the Japan Patent Office, the entire content of which is hereby incorporated by reference,

### TECHNICAL FIELD

The present invention relates to a paper sheet conveyance device that conveys a paper sheet to an image forming apparatus, specifically relates to a paper sheet conveyance device capable of correcting curls on a paper sheet in a conveyance direction, and improving stiffness of the paper sheet.

### BACKGROUND OF THE INVENTION

Conventionally, a technique to obtain better transfer state has been disclosed in which a curl correction device to correct curls on a paper sheet, which is to be conveyed to a transfer drum, is disposed upstream the transfer drum (as an example, refer to Unexamined Japanese Patent Application Publication No. 1993-27608). The curl correction device consists of a pressure roller, which includes a protruding part, in a roller length direction, having been formed into a corrugated shape in a circumferential direction, and an elastic roller opposing the pressure roller.

In recent years, the range of demand with respect to the basis weight of a paper sheet has been expanded, and needs for 40 g/m² to 350 g/m², as an, example, have arisen and diversified. In case of a conventional image forming apparatus, specifically when a low basis weight paper sheet (50 g/m² or less) is conveyed, paper jams attributable to low paper stiffness, which is one of the original properties of the paper sheet, tend to occur.

Also, after a paper sheet has been passed though a fixing device, a corner(s) of the paper sheet tends (tend) to bend due to a curl produced when the paper sheet is curved along the conveyance direction. Further, image defects, attributable to paper sheet wrinkles, or the like, caused by paper sheet entry into a fixing device when a second surface of paper sheet is to be fixed in double-sided printing, and paper jams within a conveyance path, attributable to a curl and a bend at paper sheet corner, tend to occur frequently.

In order to reduce the above-mentioned problems, it is possible to suppress curls on paper sheets by reducing fixing pressure and fixing control temperature. However, it may increase a possibility in which the fixing property of toner onto a paper sheet cannot be assured.

The technique, disclosed in the above-mentioned Unexamined Japanese Patent Application Publication No. 1993-27608, is aimed to impart a function to correct curls on curved paper sheets, during a paper sheet is conveyed through a paper sheet conveyance path upstream of the transfer drum, in a direction opposite to the curved surface direction of the transfer drum, or to impart a function to curve the paper sheet in the direction along the curved surface of the transfer drum. However, in a case in which the same functions are imparted when lower basis weight of paper sheets are used, it is a concern that image defects and paper jams, due to winding of a paper sheet around the transfer drum, are likely to occur.

### SUMMARY OF THE INVENTION

The present invention has been achieved in consideration of the above problems, and it is one of the main objects to provide, a paper sheet conveyance device and an image forming apparatus capable of appropriately reducing conveyance problems regardless of the basis weight of paper sheets to be conveyed.

[1] A paper sheet conveyance device, for conveying a paper sheet to an image forming apparatus, reflecting one aspect of the present invention includes, for example, but is not limited to, a corrugation roller for imparting corrugation onto both the left and right sides of the paper sheet, to be conveyed, with respect to a conveyance direction, by forming a curved portion along the conveyance direction.

[2] The paper sheet conveyance device of [1], reflecting another aspect of the present invention, may further includes: a conveyance roller disposed opposite to the corrugation roller; a supporting mechanism to support the corrugation roller to be movable in a direction in which the corrugation roller separates from the conveyance roller; an information setting section in which paper sheet type information for a paper sheet is set, and a control section configured to control the supporting mechanism to retract the corrugation roller from the conveyance roller in accordance with a basis weight of paper sheet based on paper sheet type information having been set in the information setting section.

[3] The paper sheet conveyance device of [1], reflecting still another aspect of the present invention, may further include: a conveyance roller disposed opposite to the corrugation roller; a pressing supporting mechanism for (a) supporting the corrugation roller to be movable in a direction in which the corrugation roller separates from the conveyance roller, and (b) pressing the corrugation roller into contact with the conveyance roller; an information setting section in which paper sheet type information for a paper sheet is set; and a control section configured to control the pressing supporting mechanism to vary a force that presses the corrugation roller into contact with the conveyance roller in accordance with a basis weight of paper sheet based on paper sheet type information having been set in the information setting section.

[4] The paper sheet conveyance device of [1], reflecting still another aspect of the present invention, may further include: a conveyance roller disposed opposite to the corrugation roller, wherein the corrugation roller includes a nipping section, facing the conveyance roller, for nipping the paper sheet, and a corrugation imparting section protruding from the nipping section on a lateral side of the conveyance roller that it is facing, wherein the corrugation roller is supported to be movable along an axis direction of the corrugation roller as the corrugation imparting section is biased via a biasing member in a direction in which the corrugation imparting section approaches the conveyance roller.

[5] The paper sheet conveyance device of [1], reflecting still another aspect of the present invention, may further include: a conveyance roller disposed opposite to the corrugation roller; a supporting mechanism for supporting the corrugation roller to be movable in an axis direction of the corrugation roller; an information setting section in which paper sheet type information for a paper sheet is set; and a control section configured to control the supporting mechanism to vary a position of the corrugation roller in the axis direction of the corrugation roller in accordance with a width of paper sheet based on paper sheet type information having been set in the information setting section.

[6] The paper sheet conveyance device of [1], reflecting still another aspect of the present invention, wherein a distance between the corrugation roller and the image forming section is configured to be a shorter distance than a minimum length of paper sheet capable of being conveyed.

### BRIEF DESCRIPTION OF THE DRAWINGS

The preferred embodiments of the present invention are shown by way of example, and not limitation, in the accompanying figures, in which:

FIG. 1 is a perspective view illustrating an example of a paper sheet conveyance device according to a preferred embodiment.

FIG. 2 is a side view illustrating an example of a paper sheet conveyance device according to a preferred embodiment

FIG. 3 is a schematic diagram illustrating an example of an image forming apparatus provided with a paper sheet conveyance device according to a preferred embodiment.

FIG. 4 is a front view illustrating an example of a paper sheet conveyance device according to a first preferred embodiment.

FIGS. 5a and 5b are each a side view illustrating an example of a paper sheet conveyance device according to a second preferred embodiment.

FIG. 6 is a front view illustrating an example of the paper sheet conveyance device according to the second preferred embodiment.

FIG. 7 is a functional block diagram illustrating an example of a control system of the paper sheet conveyance device according to the second preferred embodiment.

FIG. 8 is a flow chart illustrating an example of an operation of the paper sheet conveyance device according to the second preferred embodiment.

FIG. 9 is a side view illustrating an example of a paper sheet conveyance device according to a third preferred embodiment.

FIG. 10 is a front view illustrating an example of the paper sheet conveyance device according to the third preferred embodiment.

FIG. 11 is a functional block diagram illustrating an example of a control system of the paper sheet conveyance device according to the third preferred embodiment.

FIG. 12 is a flow chart illustrating an example of an operation of the paper sheet conveyance device according to the third preferred embodiment.

FIG. 13 is a front view illustrating an example of a paper sheet conveyance device according to a fourth preferred embodiment.

FIGS. 14a and 14b are each a front view illustrating an example of a paper sheet conveyance device according to a fifth preferred embodiment.

FIG. 15 is a functional block diagram illustrating an example of a control system of the paper sheet conveyance device according to the fifth preferred embodiment.

FIG. 16 is a flow chart illustrating an example of an operation of the paper sheet conveyance device according to the fifth preferred embodiment.

### DETAILED DESCRIPTION OF THE PREFERRED EMBODIMENTS

Hereinafter, a paper sheet conveyance device and an image forming apparatus, according to preferred embodiments of the present invention, will be described in detail with reference to the accompanying drawings, without the present invention being limited to the embodiments.

### [Overview of Paper Sheet Conveyance Device According to Preferred Embodiments]

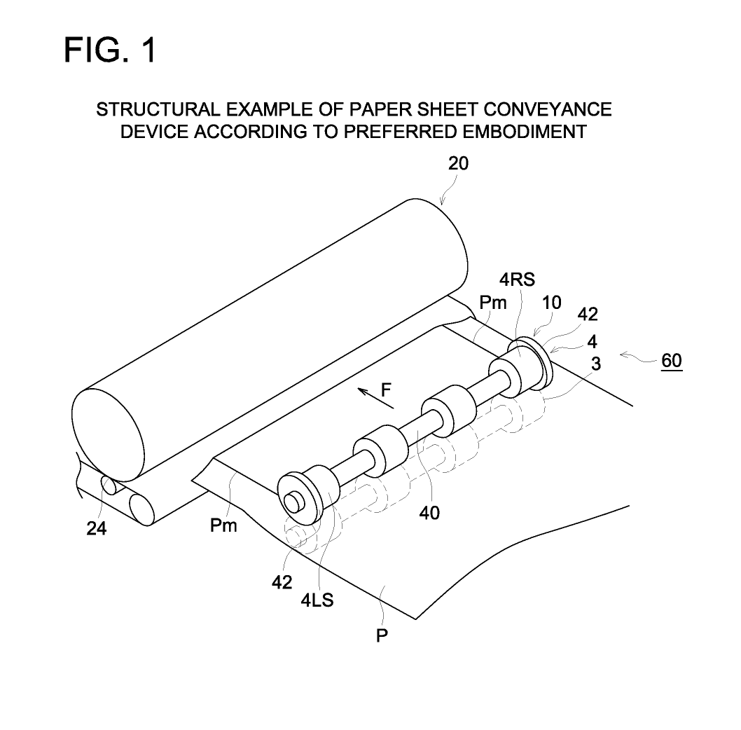

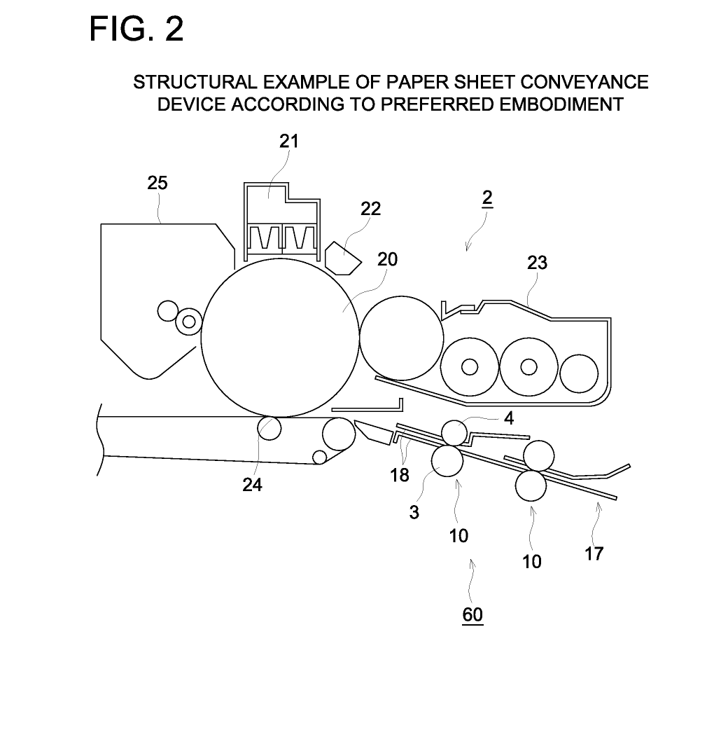

FIG. 1 is a perspective view illustrating an example of a paper sheet conveyance device according to a preferred embodiment, and FIG. 2 is a side view illustrating an example of a paper sheet conveyance device according to a preferred embodiment.

First, an overview of paper sheet conveyance device 60 according to a preferred embodiment will be described. Paper sheet conveyance device 60 consists of, but is not limited to, conveyance path 17 which conveys paper sheet P, onto which an image is formed in image forming section 2. Conveyance path 17 includes, upstream of image forming section 2 with respect to conveyance direction F of paper sheet P, a pair of conveyance rollers 10 consisting of a pair of rollers, or a plurality of pairs of conveyance rollers 10 arranged along conveyance direction F of paper sheet P.

Conveyance rollers 10 includes a corrugation roller as one of the pair of rollers, or corrugation rollers as both of the pair of rollers, which imparts (impart) corrugation, having the wave shape of a convex, or concave, or convex and concave, onto paper sheet P. Conveyance path 17 also includes guide members 18 which guide paper sheet P which is conveyed via conveyance rollers 10. Guide members 18 prevent conveyance failures from occurring in cases in which paper sheet P, onto which corrugation has been imparted, is conveyed, by having a configuration such that a pair of guide plates face each other with an interval therebetween through which curved paper sheet P, onto which corrugation has been imparted, can pass.

Conveyance rollers 10, in this example, consists of driving roller 3 as a conveyance roller and corrugation roller 4 as a driven roller which rotates by being driven by paper sheet P which is conveyed via driving roller 3. In cases in which a plurality of pairs of conveyance rollers 10 is provided in conveyance path 17, corrugation roller 4 is provided only for conveyance rollers 10 which is disposed nearest image forming section 2.

As shown in FIG. 1, corrugation roller 4 imparts corrugation onto paper sheet P, which is conveyed by being nipped between corrugation roller 4 and driving roller 3, by forming curved portion Pm along the conveyance direction of paper sheet P, as indicated by arrow F, and curves paper sheet P along a direction perpendicular to the conveyance direction.

In such a way, conveyance problems and image defects, which are attributable to the conveyance problems, in image forming section 2, are reduced by correcting curls on paper sheet P along conveyance direction F and by also improving stiffness of paper sheet P along conveyance direction F.

### [Example of Structure of an Image Forming Apparatus According to a Preferred Embodiment]

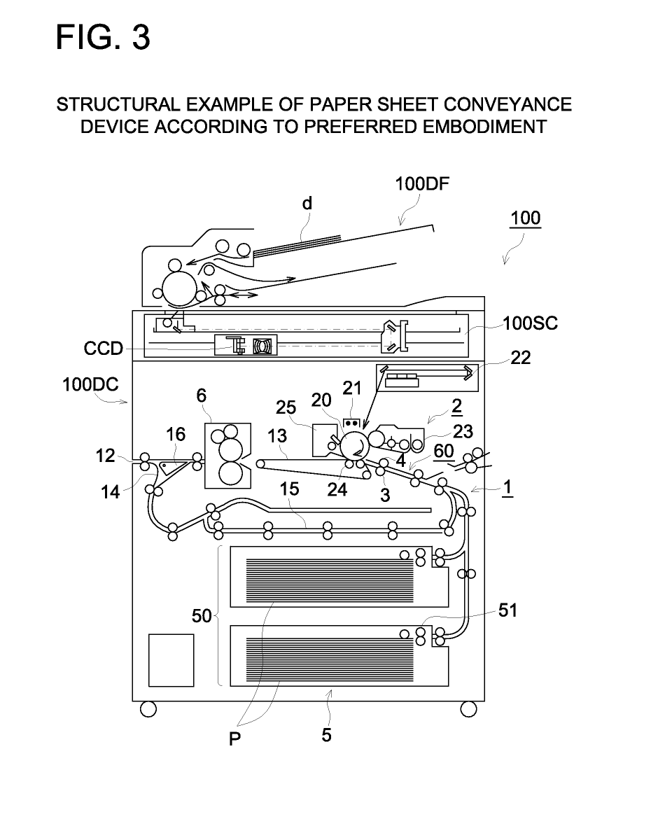

FIG. 3 is a schematic diagram illustrating an example of an image forming apparatus provided with a paper sheet conveyance device according to a preferred embodiment. An overview of the structure and operation of image forming apparatus 100, provided with paper sheet conveyance device 60 according to the preferred embodiment, will now be described.

Image forming apparatus 100 consists of, but is not limited to, image forming apparatus main-body 100DC, image reading device 100SC, and automatic document feeder 100DF. It should be noted that image forming apparatus 100 may also be structured in a constitution in which post-processing devices referred to as a large capacity paper sheet feeding unit and a finisher are connected.

Image forming apparatus 100 consists of sheet feeding section 5, to which paper sheets P are set, paper sheet conveyance system 1, which includes paper sheet conveyance device 60 according to the preferred embodiment, conveys paper sheet P, image forming section 2 which forms an image onto paper sheet P which is conveyed via paper sheet conveyance device 60, and fixing section 6 which fixes the image formed via image forming section 2.

In sheet feeding section 5, a plurality of paper sheet trays 50, onto each of which a plurality of paper sheets P is stacked and accumulated, is provided so, as to be arranged in the vertical direction, in this example. In sheet feeding section 5, separating and feeding mechanism 51, which feeds paper sheet P from sheet tray 50, is provided for each paper sheet tray 50.

Paper sheet conveyance system 1 conveys paper sheet P, which has been fed from paper sheet tray 50 in sheet feeding section 5, or fed from an external sheet feeding unit, not illustrated in the figure, to image forming section 2 via paper sheet conveyance device 60, and includes conveyance path 13 which conveys paper sheet P, onto which an image has been formed in image forming section 2, having been passed through fixing section 6, to paper sheet ejection section 12.

Paper sheet conveyance system 1 also includes, but is not limited to, conveyance path switching section 16 which switches conveyance path of paper sheet P, reversal sheet ejection section 14 which conveys paper sheet P, having been reversed, to paper sheet ejection section 12, and circulation sheet re-supplying section 15 which conveys paper sheet P, having been reversed, to paper sheet conveyance device 60.

Image forming section 2 includes, but is not limited to, photoreceptor 20 which is an image bearing member, charging section 21 which electrically charges the surface of photoreceptor 20, exposure device 22 which emits a laser beam onto the surface of photoreceptor 20, whereby an electrostatic latent image is formed, developing device 23 which develops the electrostatic latent image on the surface of photoreceptor 20 to form a toner image, transfer section 24 which transfers the toner image on the surface of photoreceptor 20 onto paper sheet P, and cleaning section 25 which cleans the surface of photoreceptor 20, and the like.

An overview of the operation of image forming apparatus 100 will be now described. At automatic document feeder 100DF, original document “d”, placed on a platen of automatic document feeder 100DF, is conveyed via document feeding section, and then the image of one surface or both surfaces of original document “d” is exposed by an optical system of image reading device 100SC, and the incident light reflecting the image is read by image sensor CCD.

The analog image signal, subjected to photoelectric conversion by image sensor CCD, undergoes analog processing, analog-to-digital conversion, shading correction and image compression processing in an image processing section (not illustrated in the figure), and the image signal is sent to exposure unit 22.

In image forming section 2, processes such as charging, exposure, developing, transfer, separation, cleaning, and the like, are carried out. In image forming section 2, the surface of photoreceptor 20 is charged by charging section 21, after that, exposure device 22 radiates laser rays onto the surface so that an electrostatic latent image is formed thereon, and developing device 23 subsequently develops the electrostatic latent image so that a toner image is formed.

Next, paper sheet P, having been stacked on paper sheet tray 50, is fed via separating and feeding mechanism 51, and conveyed via paper sheet conveyance system 1. Paper sheet P is conveyed via paper sheet conveyance device 60 while paper sheet P is synchronized with the toner image. After that, the toner image is transferred onto paper sheet P via transfer section 24, and the toner image is fixed onto paper sheet P via fixing section 6.

Paper sheet P, onto which the toner image has been fixed, is ejected to the exterior of image forming apparatus 100 via paper sheet ejection section 12. At the same time, any toner particles, remaining on the surface of photoreceptor 20, are removed by cleaning section 25. In the case of double-surfaces image formation, paper sheet P, carrying the formed image on its front surface, is conveyed to circulation sheet re-supplying section 15, so that paper sheet is reversed, and paper sheet P is conveyed to image forming section 2 again, where an image is formed on the reverse surface, and then paper sheet P, carrying images on both surfaces, is ejected to the exterior of image forming apparatus 100 via paper sheet ejection section 12. In the case of reversal sheet ejection, after paper sheet P, having been branched via conveyance path switching section 16, is switched-back through reversal sheet ejection section 14 so that paper sheet P is reversed, paper sheet P is ejected via paper sheet ejection section 12.

It should be noted that, although an image forming apparatus has been one for forming a monochrome image in the foregoing, it may also be an image forming apparatus for forming color images.

### [An Example of Structure of a Paper Sheet Conveyance Device According to a First Preferred Embodiment]

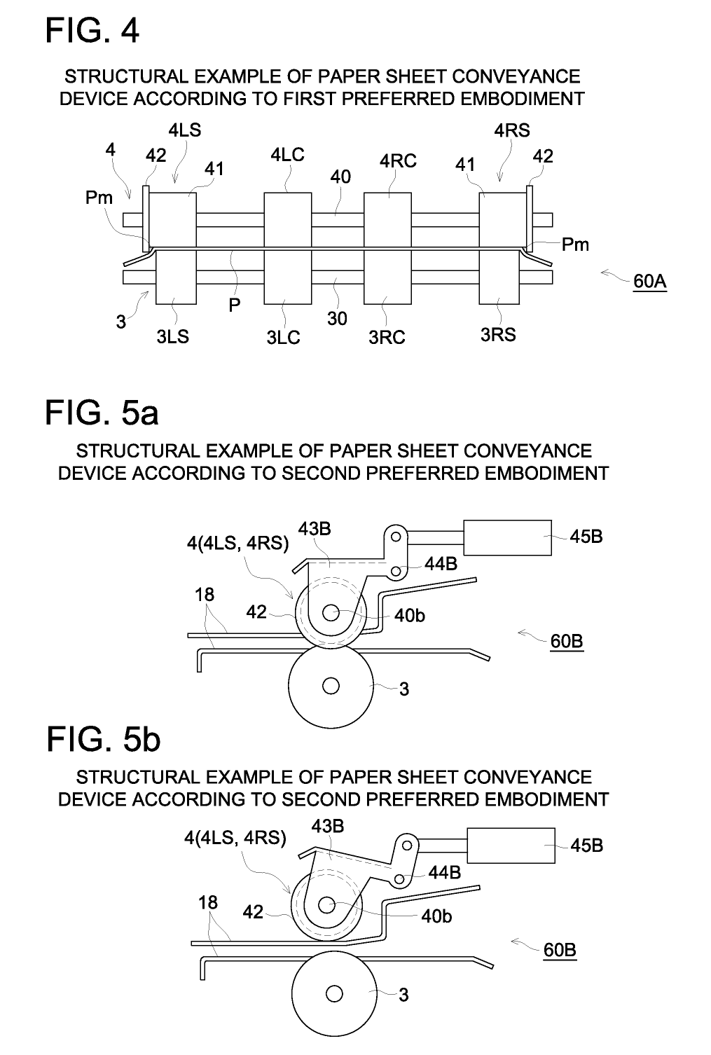

FIG. 4 is a front view illustrating an example of a paper sheet conveyance device according to a first preferred embodiment Paper sheet conveyance device 60A, according to the first preferred embodiment of paper sheet conveyance device 60, will now be described in detail with reference to the drawings.

Paper sheet conveyance device 60A, which is incorporated in the above-mentioned image forming apparatus 100, consists of conveyance path 17 which conveys paper sheet P, onto which an image is formed in image forming section 2. Conveyance path 17 includes, upstream of transfer section 24 of image forming section 2 with respect to conveyance direction F of paper sheet P, a pair of conveyance rollers 10 consisting of a pair of rollers, or a plurality of pairs of conveyance rollers 10 arranged along conveyance direction F of paper sheet P.

Also, as previously described, conveyance path 17 includes guide members 18 which guide paper sheet P which is conveyed via conveyance rollers 10. Guide members 18 prevent conveyance failures from occurring in cases in which paper sheet P, onto which corrugation has been imparted, is conveyed, by having a configuration such that a pair of guide plates face each other with an interval therebetween through which curved paper sheet P, onto which corrugation has been imparted, can pass.

In cases in which a plurality of pairs of conveyance rollers 10 is provided in conveyance path 17 of paper sheet conveyance device 60A, corrugation roller 4 is provided only for conveyance rollers 10 which is disposed nearest transfer section 24.

Conveyance rollers 10, onto which corrugation roller 4 is provided, is structured such that driving roller 3 is provided on one side of conveyance rollers 10, the lower side in this example, and corrugation roller 4 is provided to the other side of conveyance rollers 10, the upper side in this example, with respect to conveyance path 17 which consists of guide members 18. Driving roller 4 and corrugation roller 3 face in a configuration such that an interval therebetween with which one sheet of paper sheet P can be held, can be formed.

Driving roller 3 is structured such that a single or a plurality of roller bodies is provided, and in this example, four driving roller bodies 3LS (LS stands for left edge side), 3LC (LC stands for left of center), 3RC (RC stands for right of center), and 3RS (RS stands for right edge side) are provided. Driving roller 3 is structured such that driving roller bodies 3LS, 3LC, 3RC, and 3RS are attached on axis 30, which is perpendicular to conveyance direction F of paper sheet P, and are coaxially arranged on the same axis. Driving roller 3 is structured such that the width of driving roller bodies 3LS, 3LC, 3RC, and 3RS, the arrangement of these roller bodies, and the intervals therebetween, and the like, are determined in accordance with the width of paper sheet P which is subject to the image forming processing.

In this example, driving roller bodies 3LC and 3RC are arranged near left of center and near right of center of paper sheet P in the width direction, respectively, and driving roller body 3LS is arranged near the left edge side, and driving roller body 3RS is arranged near the right edge side of paper sheet P in the width direction, respectively.

Driving force from a driving means such as a motor, or the like, is transmitted to axis 30 via a gear and belt, not illustrated in the figure, and by the driving force transmitted to axis 30, driving roller bodies 3LS, 3LC, 3RC, and 3RS are driven to rotate.

Corrugation roller 4 is structured such that a plurality of roller bodies are coaxially arranged in this example, and includes two driven roller bodies 4LC and 4RC, and two corrugation roller bodies 4LS and 4RS.

Corrugation roller 4 is structured such that driven roller bodies 4LC and 4RC, and corrugation roller bodies 4LS and 4RS are attached on axis 40, which is perpendicular to conveyance direction F of paper sheet P, and are coaxially arranged on the same axis. Driving force is not transmitted to axis 40, and driven roller bodies 4LC and 4RC and corrugation roller bodies 4LS and 4RS are driven to rotate by the movement of paper sheet P which is conveyed via driving roller 3.

The width of driven roller bodies 4LC and 4RC and corrugation roller bodies 4LS and 4RS, the arrangement of these roller bodies, and the intervals therebetween, and the like, are determined based on the arrangement of driving roller bodies 3LS, 3LC, 3RC, and 3RS, and the width of paper sheet P which is subjected to the image forming processing.

Corrugation roller 4 is structured such that driven roller body 4LC is arranged to face driving roller body 3LC which is located near left of center of paper sheet P in the width direction, and driven roller body 4RC is arranged to face driving roller body 3RC which is located near right of center of paper sheet P in the width direction.

Also, corrugation roller 4 is structured such that corrugation roller body 4LS is arranged to face driving roller body 3LS which is located near the left edge side of paper sheet P in the width direction, and corrugation roller body 4RS is arranged to face driving roller body 3RS which is located near the right edge side of paper sheet P in the width direction.

Corrugation roller body 4LS includes nipping section 41 which holds paper sheet P between it and driving roller body 3LS, and corrugation imparting section 42 protruding from the outer periphery of nipping section 41. Corrugation roller body 4LS is structured such that nipping section 41 is structured so as to have the same diameters of driven roller bodies 4LC and 4RC, and corrugation imparting section 42 is structured so as to have a larger diameter than that of nipping section 41.

Corrugation roller body 4LS is structured such that the outer peripheries of nipping section 41 and corrugation imparting section 42 are concentric circular shapes, and corrugation imparting section 42 protrudes at a predetermined height from one side of the entire circumference of the outer periphery of nipping section 41.

Corrugation roller body 4LS is structured such that the width of nipping section 41 is substantially the same as that of driving roller body 3LS, and nipping section 41 faces driving roller body 3LS. Also, corrugation roller body 4LS is structured such that corrugation imparting section 42 is provided to face the outer side area of driving roller body 3LS, which faces nipping section 41, and the outer periphery of corrugation imparting section 42 does not face the outer periphery of driving roller body 3LS, and protrudes beyond the outer periphery of driving roller body 3LS on the lateral side thereof in the direction toward the axis of driving roller body 3LS.

Corrugation roller body 4RS has substantially the same constitution as corrugation roller body 4LS, and includes nipping section 41 which holds paper sheet P between it and driving roller body 3RS, and corrugation imparting section 42 protruding from the outer periphery of nipping section 41. Corrugation roller body 4RS is structured such that nipping section 41 is structured so as to have the same diameters of driven roller bodies 4LC and 4RC, and corrugation imparting section 42 is structured so as to have a larger diameter than that of nipping section 41.

Corrugation roller body 4RS is structured such that the outer peripheries of nipping section 41 and corrugation imparting section 42 are concentric circular shapes, and corrugation imparting section 42 protrudes at a predetermined height from one side of the entire circumference of the outer periphery of nipping section 41.

Corrugation roller body 4RS is structured such that the width of nipping section 41 is substantially the same as that of driving roller body 3RS, and nipping section 41 faces driving roller body 3RS. Also, corrugation roller 4RS is structured such that corrugation imparting section 42 is provided to face the outer side area of driving roller body 3RS, which faces nipping section 41, and the outer periphery of corrugation imparting section 42 does not face the outer periphery of driving roller body 3RS, and protrudes beyond the outer periphery of driving roller body 3RS on the lateral side thereof in the direction toward the axis of driving roller body 3RS.

By the above arrangement, corrugation imparting section 42 protrudes toward the side of driving roller 3 with respect to the conveyance surface formed by the region where nipping sections 41, of driven roller bodies 4LC and 4RC and corrugation roller bodies 4LS and 4RS, face driving roller bodies 3LS, 3LC, 3RC, and 3RS.

Here, the interval between conveyance rollers 10, equipped with corrugation roller 4, and transfer section 24 of image forming section 2 is set to a length which is shorter than the length, in the conveyance direction F, of minimum size paper sheet P of which the length in the conveyance direction F is a shortest among paper sheets P which are subjected to image forming processing. In this way, it is so structured that, when the leading edge of paper sheet P reaches transfer section 24 of image forming section 2, the state, in which the trailing edge of paper sheet P is nipped between driving roller 3 and corrugation roller 4, still remains.

It should be noted that, in a constitution in which a plurality of conveyance rollers 10 is provided in conveyance path 17, conveyance rollers 10, disposed upstream of conveyance rollers 10 which is equipped with corrugation roller 4, consists of the above-mentioned driving roller and driven roller which is not equipped with a corrugation imparting section.

### [Example of Operation of a Paper Sheet Conveyance Device According to the First Preferred Embodiment]

Next, paper sheet conveyance device 60A, incorporated in image forming apparatus 100, will be described in detail with reference to the drawings. In image forming apparatus illustrated in FIG. 3, paper sheet P, having been stacked on paper sheet tray 50, is fed by separating and feeding mechanism 51, and conveyed via paper sheet conveyance device 60A which constitutes paper sheet conveyance system 1.

In paper sheet conveyance device 60A, paper sheet P, to be conveyed by being nipped between driving roller 3 and corrugation roller 4, is curved at both the left and right sides of the paper sheet, with respect to conveyance direction F, via corrugation imparting section 42 of corrugation roller bodies 4LS and 4RS, and curved portion Pm, along conveyance direction F, is formed as shown in FIG. 1. By curved portion Pm, which is formed along conveyance direction F at both the left and right sides of the paper sheet, with respect to conveyance direction F, paper sheet P is curved in a direction perpendicular to the conveyance direction F, and corrugation is imparted.

In this way, curls on paper sheet P along conveyance direction F, paper sheet P which is to be conveyed to transfer section 24 of image forming section 2, are corrected, and also, stiffness of paper sheet P along conveyance direction F is improved. Because paper sheet P, of which curls have been corrected, and stiffness has also been improved, is conveyed to image forming section 2, conveyance failures and image forming failures attributable to conveyance failures are reduced. Also, because similar effects can be obtained in cases in which a paper sheet is reversed and conveyed in double-sided printing, conveyance failures in the cases can also be reduced.

Also, when the leading edge of paper sheet P reaches transfer section 24 of image forming section 2, the state, in which the trailing edge of paper sheet P is nipped between driving roller 3 and corrugation roller 4, still remains. In this way, the state in which corrugation has been imparted remains, and even in a case in which the basis weight of paper sheet P is low, curling along conveyance direction F can be corrected, and stiffness along conveyance direction F can also be improved.

Here, the shape of curved portion Pm is set by the height of protrusion of corrugation imparting sections 42 of corrugation roller bodies 4LS and 4RS, and by the clearance gap between corrugation imparting sections 42 and driving rollers 3LS and 3RS in the direction of axis 30.

The shape of curved portion Pm, to be formed on paper sheet P, should be made to be one which is able to curve paper sheet P along the direction perpendicular to the conveyance direction F to the extent that the curved portion Pm is able to correct curls on paper sheet P along conveyance direction F, and also improve stiffness of paper sheet P along conveyance direction F. At the same time, the shape of curved portion Pm should be made to be one in which this curved portion Pm does not remain as a fold and curling along the direction perpendicular to conveyance direction F is restorable.

Therefore, the height of protrusion of corrugation imparting sections 42 of corrugation roller bodies 4LS and 4RS, and the clearance gap between corrugation imparting sections 42 and driving rollers 3LS and 3RS in the direction of axis 30 should be configured so as to satisfy the above-mentioned conditions.

### [An Example of Structure of a Paper Sheet Conveyance Device According to a Second Preferred Embodiment]

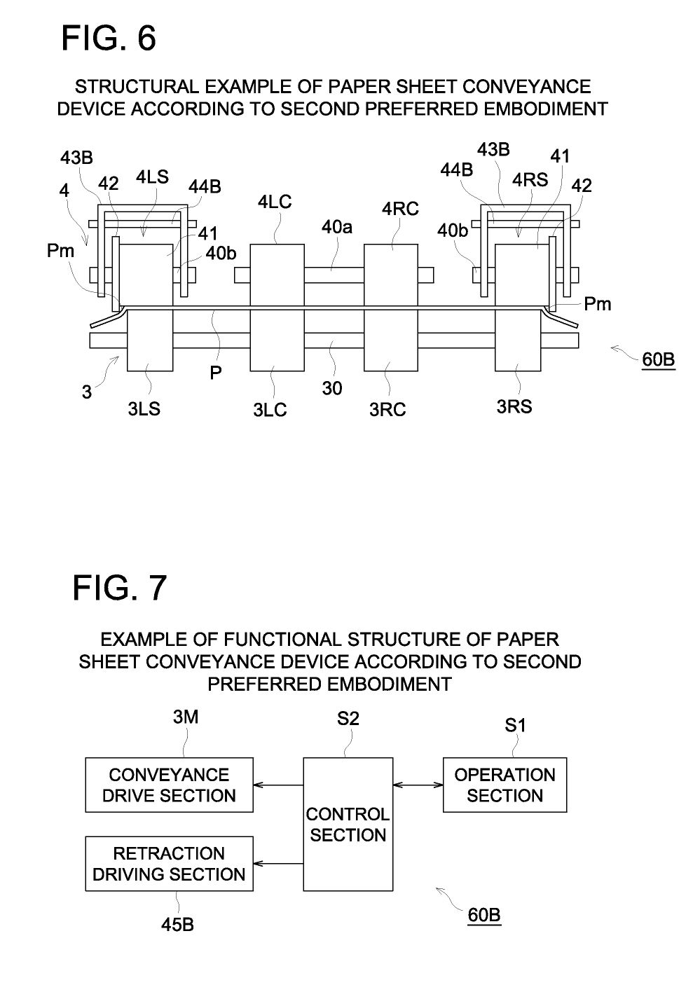

FIGS. 5a and 5b are each a side view illustrating an example of a paper sheet conveyance device according to a second preferred embodiment. FIG. 6 is a front view illustrating the example of the paper sheet conveyance device according to the second preferred embodiment. Paper sheet conveyance device 60B, according to the second preferred embodiment of paper sheet conveyance device 60, will now be described in de ail with reference to the drawings.

Paper sheet conveyance device 60B, which is incorporated in the above-mentioned image forming apparatus 100, consists of conveyance rollers 10, which is consisted of a pair of rollers, disposed upstream of image forming section 2. Conveyance rollers 10, which is disposed upstream of transfer section 24 and is disposed nearest transfer section 24, consists of driving roller 3, which is driven to rotate, and corrugation roller 4, which is disposed facing driving roller 3 and is disposed to be movable in a direction in which conveyance rollers 10 separates from driving roller 3, as a driven roller which is disposed facing driving roller 3 and rotates by being driven by paper sheet P which is conveyed via driving roller 3.

Driving roller 3, in this example, is structured such that four driving roller bodies 3LS, 3LC, 3RC, and 3RS are attached on axis 30, which is perpendicular to conveyance direction F of paper sheet P, and are coaxially arranged on the same axis. Driving force from a driving means such as a motor, or the like, is transmitted to axis 30 via a gear and belt, not illustrated in the figure, and by the driving force transmitted to axis 30, driving roller bodies 3LS, 3LC, 3RC, and 3RS are driven to rotate.

Corrugation roller 4 is structured, in this example, such that two driven roller bodies 4LC and 4RC, and two corrugation roller bodies 4LS and 4RS. Corrugation roller 4 is structured such that driven roller bodies 4LC and 4RC are attached on axis 40a, which is perpendicular to conveyance direction F of paper sheet P, and are coaxially arranged on the same axis. Corrugation roller 4 is structured such that each of corrugation roller bodies 4LS and 4RS is attached on each axis 40b, which is perpendicular to conveyance direction F of paper sheet P and is independent of axis 40a.

Corrugation roller 4 is structured such that no driving force is transmitted to axes 40a or 40b, and driven roller bodies 4LC and 4RC and corrugation roller bodies 4LS and 4RS are driven to rotate by the movement of paper sheet P which is conveyed via driving roller 3.

Corrugation roller 4 is structured such that each of axes 40b of corrugation roller bodies 4LS and 4RS is supported by each supporting member 43B which constitutes a supporting mechanism. Supporting member 43B rotates about axis 44B serving as a rotation center, and supports corrugation roller bodies 4LS and 4RS of corrugation roller 4 to be movable, being independent of driven roller bodies 4LC and 4RC, in a direction in which corrugation roller bodies 4LS and 4RS, of corrugation roller 4, separate from driving roller 3.

Paper sheet conveyance device 60B consists of retraction driving section 45B to retract corrugation roller bodies 4LS and 4RS of corrugation roller 4. Retraction driving section 45B constitutes a supporting mechanism, and moves corrugation roller bodies 4LS and 4RS of corrugation roller 4, either manually or via a driving means, in the direction in which corrugation roller bodies 4LS and 4RS separate from driving roller 3.

Retraction driving section 45B consists of a solenoid, or the like, in this example, and drives supporting member 43B to rotate corrugation roller bodies 4LS and 4RS of corrugation roller 4 in the direction in which corrugation roller bodies 4LS and 4RS are separated from, or are pressed into contact with, driving roller 3.

Corrugation roller body 4LS is structured such that nipping section 41 is disposed opposite to driving roller body 3LS, and corrugation imparting section 42 is provided to face the outer side area of driving roller body 3LS. The outer periphery of corrugation imparting section 42 does not face the outer periphery of driving roller body 3LS, and protrudes beyond the outer periphery of driving roller body 3LS on the lateral side thereof in the direction toward the axis of driving roller body 3LS.

Corrugation roller body 4RS has substantially the same constitution as corrugation roller body 4LS, and is structured such that nipping section 41 faces driving roller body 3RS, and corrugation imparting section 42 is provided to face the outer side area of driving roller body 3RS. The outer periphery of corrugation imparting section 42 does not face the outer periphery of driving roller body 3RS, and protrudes beyond the outer periphery of driving roller body 3RS on the lateral side thereof in the direction toward the axis of driving roller body 3RS.

FIG. 7 is a functional block diagram illustrating an example of a control system of the paper sheet conveyance device according to the second preferred embodiment. Paper sheet conveyance device 60B consists of conveyance drive section 3M consisted of a motor, or the like, which drives driving roller 3, and the above-mentioned retraction driving section 45B to move corrugation roller bodies 4LS and 4RS of corrugation roller 4 in the direction in which corrugation roller bodies 4LS and 4RS separate from driving roller 3.

Also, paper sheet conveyance device 60B consists of operation section S1 in which information to set the basis weight of paper sheet P, as an example, paper sheet type information, or the like, is selected, and control section S2 configured to convey paper sheet P by controlling conveyance drive section 3M and to control retraction driving section 45B, based on the basis weight of a paper sheet, or the like, having been set via operation section S1.

It should be noted that, in the case in which paper sheet conveyance device 60B is incorporated in the above-mentioned image forming apparatus 100, operation section S1 and control section S2 is structured of an operation section and a control section of image forming apparatus 100. Also, conveyance drive section 3M is structured of motors, or the like, which drive driving rollers, or the like, in paper sheet conveyance system 1 of image forming apparatus 100.

In cases in which the basis weight of paper sheet P is lower than a predetermined basis weight, control section S2 controls retraction driving section 45B to move corrugation roller bodies 4LS and 4RS of corrugation roller 4 to a predetermined position in the direction in which corrugation roller bodies 4LS and 4RS approach driving roller 3.

In cases in which the basis weight of paper sheet P is equal to or higher than the predetermined basis weight, control section S2 controls retraction driving section 45B to move corrugation roller bodies 4LS and 4RS of corrugation roller 4 to a predetermined position in the direction in which corrugation roller bodies 4LS and 4RS separate from driving roller 3.

In this example, when the basis weight of paper sheet P is less than 50 g/m², it is referred to as low basis weight. When the basis weight of paper sheet P is the predetermined low basis weight, corrugation roller bodies 4LS and 4RS are coaxially (concentrically) positioned with driven roller bodies 4LC and 4RC so that corrugation imparting section 42 protrudes.

When the basis weight of paper sheet P is equal to or more than 50 g/m², it is referred to as standard basis weight. When the basis weight of paper sheet P is the predetermined standard basis weight, corrugation roller bodies 4LS and 4RS are refracted.

### [Example of Operation of a Paper Sheet Conveyance Device According to the Second Preferred Embodiment]

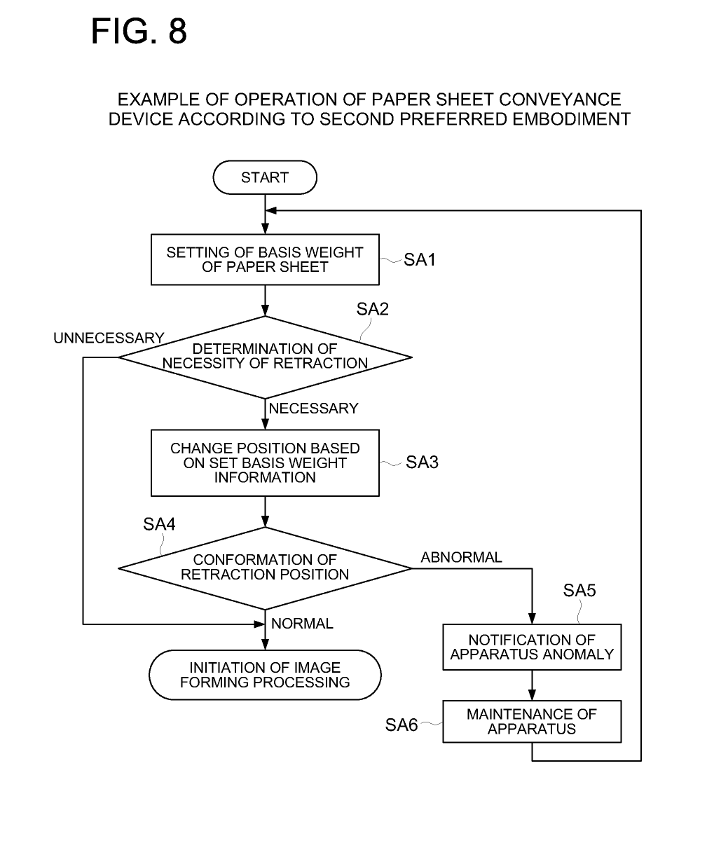

FIG. 8 is a flow chart illustrating an example of an operation of the paper sheet conveyance device according to the second preferred embodiment, and an operation of paper sheet conveyance device 60B, incorporated in image forming apparatus 100, will be described in detail with reference to the drawings.

To begin with, the basis weight of paper sheet P is set in step SA1 in FIG. 8. The basis weight of paper sheet P is set by selecting the type of paper sheet P, or the type and the basis weight of paper sheet P via operation section S1, in conformity with paper sheet P having been stacked in paper sheet trays 50.

Next, in step SA2 in FIG. 8, control section S2 determines whether or not corrugation roller 4 is to be retracted. As an example, in control section S2, whether the basis weight of paper sheet P, having been set at the time of previous image formation, or the like, is the above-mentioned predetermined low basis weight or standard basis weight, is memorized, and control section 2 determines whether corrugation roller 4 is to be retracted or not based on whether the basis weight of paper sheet P, having been set as the basis weight at this time, is the predetermined low basis weight or standard basis weight.

Control section S2 is configured to maintain corrugation imparting section 42 of corrugation roller bodies 4LS and 4RS in a state of protrusion in cases in which the basis weight of paper sheet P, having been set at the time of previous image formation, or the like, is the predetermined low basis weight and the basis weight of paper sheet P, having been set as the basis weight at this time, is the predetermined low basis weight, and to initiate the image forming processing. Meanwhile, control section S2 is configured to maintain corrugation imparting section 42 of corrugation roller bodies 4LS and 4RS in a state of retraction in cases in which the basis weight of paper sheet P, having been set at the time of previous image formation, or the like, is the predetermined standard basis weight and the basis weight of paper sheet P, having been set as the basis weight at this time, is the predetermined standard basis weight, and to initiate the image forming processing.

In cases in which the basis weight of paper sheet P, having been set at the time of previous image formation, or the like, is the predetermined standard basis weight, and the basis weight of paper sheet P, having been set as the basis weight at this time, is the predetermined low basis weight, control section S2 controls retraction driving section 45B to rotate supporting member 43B in the direction in which corrugation roller bodies 4LS and 4RS approach driving roller 3. Then, corrugation roller bodies 4LS and 4RS are positioned coaxially with driven roller bodies 4LC and 4RC so that corrugation imparting section 42 protrudes.

In cases in which the basis weight of paper sheet P, having been set at the time of previous image formation, or the like, is the predetermined low basis weight, and the basis weight of paper sheet P, having been set as the basis weight at this time, is the predetermined standard basis weight, control section S2 controls retraction driving section 45B to rotate supporting member 43B in the direction in which corrugation roller bodies 4LS and 4RS separate from driving roller 3. In this way, corrugation roller bodies 4LS and 4RS are retracted from driving roller 3.

When control section S2 has carried out the control of separation of corrugation roller bodies 4LS and 4RS from driving roller 3 in step SM in FIG. 8, control section S2 determines, in step SA4, whether or not the separation operation has been carried out normally.

In cases in which control section S2 has determined, in step SA4 in FIG. 8, that the operation to retract corrugation roller bodies 4LS and 4RS, or the operation to protrude corrugation imparting section 42, has not been completed normally, control section S2 notifies, in step SA5, that a failure has occurred in the apparatus via a screen display or the like, in operation section S1. It should be noted that, in cases in which a service person in charge of maintenance, or the like, has corrected the failure and an abnormal signal, which indicates that a failure has occurred in the apparatus, has been reset in step SA6, the process flow returns to step SA1, namely, “setting of basis weight of paper sheet P”.

In cases in which control section S2 has determined, in step SA4 in FIG. 8, that the operation to retract corrugation roller bodies 4LS and 4RS, or the operation to protrude corrugation imparting section 42 has been completed normally, control section S2 initiates the image forming processing.

In eases in which the basis weight of paper sheet P, having been set, is the predetermined low basis weight, control section 42 controls to protrude corrugation imparting section 42 by positioning corrugation roller bodies 4LS and 4RS coaxially with driven roller bodies 4LC and 4RC.

In the image forming processing, paper sheet P, to be conveyed by being nipped between driving roller 3 and corrugation roller 4, is curved at both the left and right sides of the paper sheet, with respect to conveyance direction F, via corrugation imparting section 42 of corrugation roller bodies 4LS and 4RS, and curved portion Pm along conveyance direction F is formed. By curved portion Pm which is formed along conveyance direction F at both the left and right sides of the paper sheet, with respect to conveyance direction F, paper sheet P is curved in a direction perpendicular to the conveyance direction F, and corrugation is imparted.

In this way, in cases in which the basis weight of paper sheet P is the predetermined low basis weight, because corrugation is imparted, curls on paper sheet P, along conveyance direction F, which is to be conveyed to transfer section 24 of image forming section 2, are corrected, and also, stiffness of paper sheet P along conveyance direction F is improved. Because paper sheet P, of which curls have been corrected, and stiffness has also been improved, is conveyed to image forming section 2, conveyance failures and image forming failures attributable to conveyance failures are reduced.

In cases in which the basis weight of paper sheet P is the predetermined standard basis weight, corrugation imparting section 42 does not come into contact with paper sheet P by retracting corrugation roller bodies 4LS and 4RS, in this example.

In the image forming processing, paper sheet P is nipped between driving roller 3 and driven roller bodies 4LC and 4RS, and conveyed, and in cases in which the basis weight of paper sheet P is the standard basis weight, corrugation is not imparted. When the basis weight of paper sheet P is the standard basis weight, curling along conveyance direction F is less likely to occur, and also, stiffness of paper sheet P along conveyance direction F is assured. In this way, conveyance problems and image defects, which are attributable to the conveyance problems, in image forming section 2, are reduced.

Also, in cases in which the basis weight of paper sheet P, having been set, is the standard basis weight, streaking on paper sheet P along the conveyance direction, cased by corrugation roller 4, can be prevented in such a way that corrugation imparting section 42 does not come into contact with paper sheet P.

Also, in cases in which the operation to retract corrugation roller bodies 4LS and 4RS, or the operation to protrude corrugation imparting section 42, by carrying out the above-mentioned error handling procedure, the conveyance of a low basis weight paper sheet P, in the state in which corrugation roller bodies 4LS and 4RS have been retracted, is prevented. Also, the conveyance of a standard basis weight paper sheet P, in the state in which corrugation imparting section 42 protrudes, is prevented. Whereby, conveyance failures and the attachment of stains to paper sheet P can be prevented.

In the second preferred embodiment, whether corrugation roller bodies 4LS and 4RS are retracted or not retracted is switched based on whether the basis weight of paper sheet P is the predetermined low basis weight or standard basis weight. It should be noted, however, that it may be configured such that the setting of basis weight may be set by more than or equal to two types, and the amount of protrusion of corrugation imparting section 42 can be changed in accordance with the basis weight.

### [An Example of Structure of a Paper Sheet Conveyance Device According to a Third Preferred Embodiment]

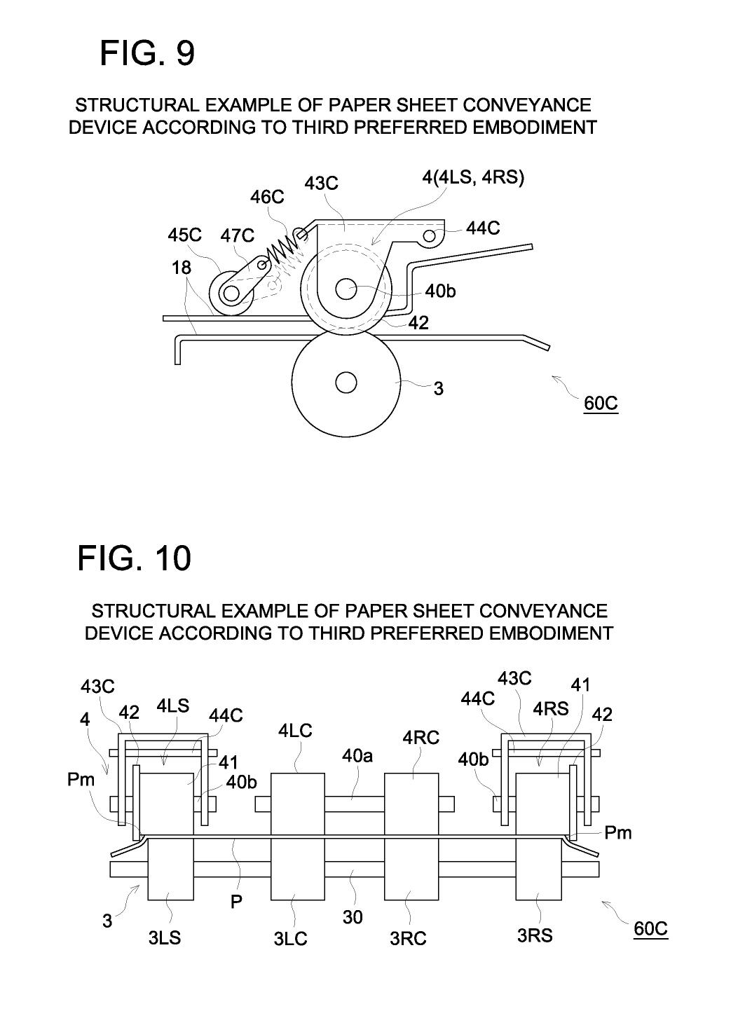

FIG. 9 is a side view illustrating an example of a paper sheet conveyance device according to a third preferred embodiment. FIG. 10 is a front view illustrating the example of the paper sheet conveyance device according to the third preferred embodiment. Paper sheet conveyance device 60C, according to the third preferred embodiment of paper sheet conveyance device 60, will now be described in detail with reference to the drawings.

Paper sheet conveyance device 60C is incorporated in the above-mentioned image forming apparatus 100, and consists of conveyance rollers 10, consisting of a pair of rollers, disposed upstream of transfer section 24 of image forming section 2. Conveyance rollers 10, which is disposed upstream and nearest transfer section 24, consists of driving roller 3, which is driven to rotate, and corrugation roller 4, which is disposed facing driving roller 3, as a driven roller which rotates by being driven by paper sheet P which is conveyed via driving roller 3, corrugation roller 4 which is disposed to be movable in a direction in which conveyance rollers 10 separates from driving roller 3.

Driving roller 3, in this example, is structured such that four driving roller bodies 3LS, 3LC, 3RC, and 3RS are attached on axis 30, which is perpendicular to conveyance direction F of paper sheet P, and are coaxially arranged on the same axis. Driving force from a driving means, such as a motor or the like, is transmitted to axis 30 via a gear and belt, not illustrated in the figure, and by the driving force transmitted to axis 30, driving roller bodies 3LS, 3LC, 3RC, and 3RS are driven to rotate.

Corrugation roller 4 consists of, in this example, two driven roller bodies 4LC and 4RC, and two corrugation roller bodies 4LS and 4RS. Corrugation roller 4 is structured such that driven roller bodies 4LC and 4RC are attached on axis 40a, which is perpendicular to conveyance direction F of paper sheet P. Also, corrugation roller 4 is structured such that each of corrugation roller bodies 4LS and 4RS is attached on each axis 40b, which is perpendicular to conveyance direction F of paper sheet P and is independent of axis 40a.

Corrugation roller 4 is structured such that no driving force is transmitted to axis 40a or axes 40b, and driven roller bodies 4LC and 4RC and corrugation roller bodies 4LS and 4RS are driven to rotate by the movement of paper sheet P which is conveyed via driving roller 3.

Corrugation roller 4 is structured such that each axis 40b of corrugation roller bodies 4LS and 4RS is supported by supporting member 43C which constitutes a pressing supporting mechanism. Supporting member 43C rotates about axis 44C serving as a rotation center, and supports corrugation roller bodies 4LS and 4RS of corrugation roller 4 to be movable, being independent of driven roller bodies 4LC and 4RC, in a direction in which corrugation roller bodies 4LS and 4RS of corrugation roller 4 separate from driving roller 3.

Paper sheet conveyance device 60C consists of spring 46C, which biases corrugation roller bodies 4LS and 4RS of corrugation roller 4 in the direction toward driving roller 3, and pressing force adjusting drive section 45C which adjusts the load of spring 46C. Spring 46C, which constitutes a pressing supporting mechanism, is structured of a coil spring, one end thereof is attached to supporting member 43C, and the other end thereof is attached to cam 47C which constitutes pressing force adjusting drive section 45C.

Pressing force adjusting drive section 45C switches the pulling force of spring 46C by rotating, cam 47C by driving cam 47C manually or via a driving means. Spring 46C biases corrugation roller bodies 4LS and 4RS of corrugation roller 4 in the direction toward driving roller 3, and by changing the pulling force of spring 46C, the pressing force of corrugation roller bodies 4LS and 4RS can be changed.

Pressing force adjusting drive section 45C consists of, in this example, a rotary encoder, or the like, which detects the rotation number of drive axis of a motor, or the like, and drives cam 47C to rotate either clockwise or counterclockwise so as to rotate in the direction in which the magnitude of the pulling force of spring 46C can be changed. Also, pressing force adjusting drive section 45C outputs a detection signal corresponding to the rotational movement of cam 47C.

Corrugation roller body 4LS is structured such that nipping section 41 is disposed opposite to driving roller body 3LS, and corrugation imparting section 42 is provided to face the outer side area of driving roller body 3LS. The outer periphery of corrugation imparting section 42 does not face the outer periphery of driving roller body 3LS, and protrudes beyond the outer periphery of driving roller body 3LS on the lateral side thereof in the direction toward the axis of driving roller body 3LS.

Corrugation roller body 4RS has substantially the same constitution as corrugation roller body 4LS, and is structured such that nipping section 41 faces driving roller body 3RS, and corrugation imparting section 42 is provided to face the outer side area of driving roller body 3RS. The outer periphery of corrugation imparting section 42 does not face the outer periphery of driving roller body 3RS, and protrudes beyond the outer periphery of driving roller body 3RS on the lateral side thereof in the direction toward the axis of driving roller body 3RS.

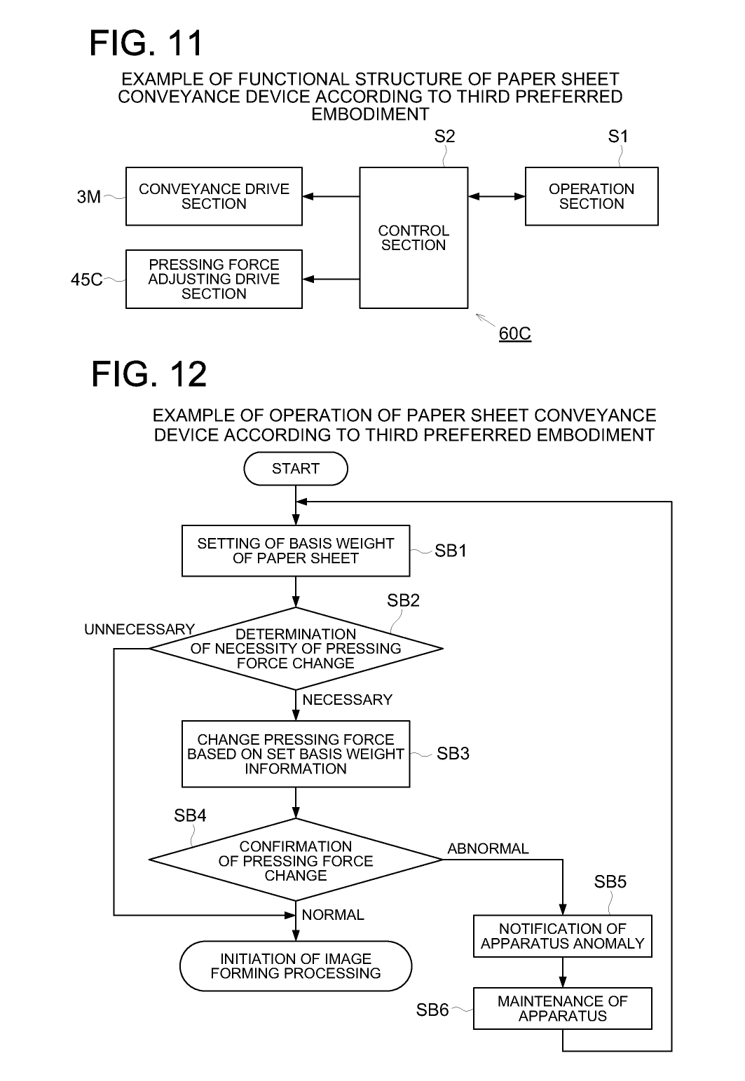

FIG. 11 is a functional block diagram illustrating an example of a control system of the paper sheet conveyance device according to the third preferred embodiment. Paper sheet conveyance device 60C consists of conveyance drive section 3M, which is consisted of a motor or the like, which drives driving roller 3, and the above-mentioned pressing force adjusting drive section 45C to rotate cam 47C in the direction in which the magnitude of the pulling force of spring 46C can be changed.

Also, paper sheet conveyance device 60C consists of operation section S1 in which information to set the basis weight of paper sheet P, as an example, paper sheet type information or the like, is selected, and control section S2 configured to convey paper sheet P by controlling conveyance drive section 3M and to control pressing force adjusting drive section 45C based on the basis weight of a paper sheet, or the like, having been set via operation section S1.

It should be noted that, in the case in which paper sheet conveyance device 60C is incorporated in the above-mentioned image forming apparatus 100, operation section Si and control section S2 is structured of an operation section and a control section of image forming apparatus 100. Also, conveyance drive, section 3M is structured of motors or the like, which drive driving rollers or the like, in paper sheet conveyance system 1 of image forming apparatus 100.

In cases in which the basis weight of paper sheet P is lower than a predetermined basis weight, control section S2 controls to increase the pressing force of corrugation roller 4 onto paper sheet P, and controls pressing force adjusting drive section 45C to rotate in the direction in which the pulling force of spring 46C increases.

In cases in which the basis weight of paper sheet P is higher than a predetermined basis weight, control section S2 controls to decrease the pressing force of corrugation roller 4 onto paper sheet P, and controls pressing force adjusting drive section 45C to rotate in the direction in which the pulling force of spring 46C decreases.

### [Example of Operation of a Paper Sheet Conveyance Device According to the Third Preferred Embodiment]

FIG. 12 is a flow chart illustrating an example of an operation of the paper sheet conveyance device according to the third preferred embodiment, and an operation of paper sheet conveyance device 60C, which is incorporated in image forming apparatus 100, will now be described in detail with reference to the drawings.

To begin with, the basis weight of paper sheet P is set in step SB1 in FIG. 12. The basis weight of paper sheet P is set by selecting the type of paper sheet P, or the type and the basis weight of paper sheet P, via operation section S1, in conformity with paper sheets P having been stacked on paper sheet trays 50.

Next, in step SB2 in FIG. 12, control section S2 determines whether or not the pressing force of corrugation roller 4 onto paper sheet P is to be changed. As an example, in control section S2, the basis weight of paper sheet P, having been set at the time of previous image formation, or the like, is memorized, and control section 2 determines whether or not the pressing force of corrugation roller 4 needs to be changed based on whether the basis weight of paper sheet P, having been set as the basis weight at this time, is the same as the basis weight, having been set at the previous time, or not.

Control section S2 is configured to initiate the image forming processing without changing the pressing force in cases in which the basis weight of paper sheet P, having been set at the time of previous image formation, or the like, and the basis weight of paper sheet P, having been set as the basis weight at this time, is the same. On the other hand, in cases in which the basis weight of paper sheet P, having been set at the time of previous image formation, or the like, and the basis weight of paper sheet P, having been set as the basis weight at this time, is not the same, control section S2 changes the pressing force based on the basis weight information in step SB3 in FIG. 12.

In cases in which the basis weight of paper sheet P, having been set at this time, is the predetermined low basis weight, control section S2 controls pressing force adjusting drive section 45C to rotate cam 47C in the direction in which the pulling force of spring 46C increases, and increases the pressing force of corrugation roller bodies 4LS and 4RS onto paper sheet P in accordance with the basis weight information.

In cases in which the basis weight of paper sheet P, having been set at this time, is a predetermined standard basis weight, control section S2 controls pressing force adjusting drive section 45C to rotate cam 47C in the direction in which the pulling force of spring 46C decreases, and thus decreases the pressing force of corrugation roller bodies 4LS and 4RS onto paper sheet P in accordance with the basis weight information.

When control section S2 has carried out the control to change the pressing force in step SB3 in FIG. 12, control section S2 determines, in step SB4, whether or not the change of the pressing force has been carried out normally. In this example, control section S2 determines whether or not cam 47C has rotated by a predetermined amount to rotate in accordance with the control, from the relationship between the basis weight information, having been previously set, and the amount of rotation of cam 47C, based on the detection signal output from a rotary encoder, not illustrated in the figure.

In cases in which control section S2 has determined, in step SB4 in FIG. 12, that the change of the pressing force has not been carried out normally, control section S2 notifies, in step SB5, that a failure has occurred in the apparatus via a screen display or the like, in operation section S1. It should be noted that, in cases in which a service person in charge of maintenance or the like, has corrected the failure and an abnormal signal, which indicates that a failure has occurred in the apparatus, has been reset in step SB6, the process flow returns to step SB1, namely, “setting of basis weight of paper sheet P”.

In cases in which control section S2 has determined, in step SB4 in FIG. 12, that the change of the pressing force has been carried out normally, control section S2 initiates the image forming processing.

In the image forming processing, paper sheet P, to be conveyed by being nipped between driving roller 3 and corrugation roller 4, is curved at both the left and right sides of the paper sheet, with respect to conveyance direction F, via corrugation imparting section 42 of corrugation roller bodies 4LS and 4RS, and curved portion Pm along conveyance direction F is formed. By curved portion Pin, which is formed along conveyance direction F at both the left and right sides of the paper sheet, with respect to conveyance direction F, paper sheet P is curved in a direction perpendicular to the conveyance direction F, and corrugation is imparted.

hi cases in which the basis weight of paper sheet P, having been set, is the predetermined low basis weight, by increasing the pulling force of spring 46C, the pressing force of corrugation roller bodies 4LS and 4RS onto paper sheet P has increased in accordance with the basis weight information. In the case of paper sheet P of the predetermined lower basis weight, the amount of protrusion of corrugation imparting section 42 increases when paper sheet P is nipped, between driving roller 3 and corrugation roller 4, and conveyed, by increasing the pulling force of corrugation roller bodies 4LS and 4RS, thus, the pressing force of corrugation imparting section 42 increases.

In this way, in cases in which the basis weight of paper sheet P is the predetermined low basis weight, because corrugation is imparted, curls on paper sheet P along conveyance direction F, paper sheet P which is to be conveyed to transfer section 24 of image forming section 2, are corrected, and also, stiffness of paper sheet P along conveyance direction F is improved. Because paper sheet P, of which curls have been corrected, and stiffness has also been improved, is conveyed to image forming section 2, conveyance failures and image forming failures attributable to conveyance failures are reduced.

In cases in which the basis weight of paper sheet P, having been set, is the predetermined standard basis weight, by decreasing the pulling force of spring 46C, the pressing force of corrugation roller bodies 4LS and 4RS onto paper sheet P has decreased in accordance with the basis weight information. In the case of paper sheet P of the predetermined standard basis weight, the amount of protrusion of corrugation imparting section 42 decreases when paper sheet P is nipped, between driving roller 3 and corrugation roller 4, and conveyed, by decreasing the pulling force of corrugation roller bodies 4LS and 4RS, thus, the pressing force of corrugation imparting section 42 decreases.

In cases in which the basis weight of paper sheet P is the predetermined standard basis weight, curling along conveyance direction F is less likely to occur even if corrugation is imparted weakly, or corrugation is not imparted, and also, stiffness of paper sheet P along conveyance direction F is assured. In this way, conveyance problems and image defects, which are attributable to the conveyance problems, are reduced.

Therefore, in cases in which the basis weight of paper sheet P, having been set, is the predetermined standard basis weight, streaking on paper sheet P along the conveyance direction, cased by corrugation roller 4, can be prevented by decreasing the pressing force of corrugation imparting section 42.

Also, in cases in which the operation to adjust the pressing force has not been carried out normally, by carrying out the above-mentioned error handling procedure, the conveyance of paper sheet P of a low basis weight, in the state in which the pressing force is weak, is prevented. Also, the conveyance of paper sheet P of a standard basis weight, in the state in which the pressing force is strong, is prevented. Thus, conveyance failures and the attachment of stains to paper sheet P can be prevented.

### [An Example of Structure of a Paper Sheet Conveyance Device According to a Fourth Preferred Embodiment]

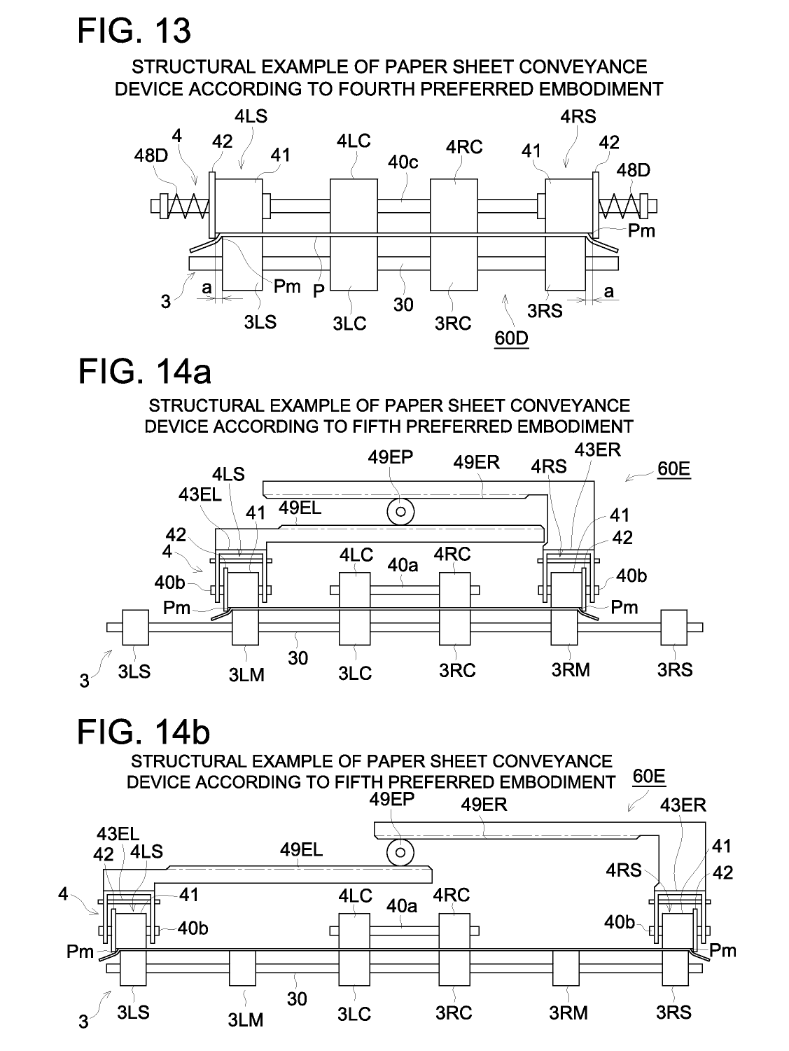

FIG. 13 is a front view illustrating an example of a paper sheet conveyance device according to a fourth preferred embodiment. Paper sheet conveyance device 60D, according to the fourth preferred embodiment of paper sheet conveyance device 60, will now be described in detail with reference to the drawings.

Paper sheet conveyance device 60D is incorporated in the above-mentioned image forming apparatus 100, and consists of conveyance rollers 10, consisting of a pair of rollers, disposed upstream of image forming section 2. Conveyance rollers 10, which is disposed upstream and nearest image forming section 2, consists of driving roller 3, which is driven to rotate, and corrugation roller 4, which is disposed facing driving roller 3, as a driven roller which rotates by being driven by paper sheet P which is conveyed via driving roller 3, corrugation roller 4 which is disposed to be movable in a direction in which conveyance rollers 10 separates from driving roller 3.

Driving roller 3, in this example, is structured such that four driving roller bodies 3LS, 3LC, 3RC, and 3RS are attached on axis 30, which is perpendicular to conveyance direction F of paper sheet P, and are coaxially arranged on the same axis. Driving force, from a driving means such as a motor or the like, is transmitted to axis 30 via a gear and belt, not illustrated in the figure, and via the driving force transmitted to axis 30, driving roller bodies 3LS, 3LC, 3RC, and 3RS are driven to rotate.

Corrugation roller 4 consists of, in this example, two driven roller bodies 4LC and 4RC, and two corrugation roller bodies 4LS and 4RS. Corrugation roller 4 is structured such that driven roller bodies 4LC and 4RC are attached on axis 40c, which is perpendicular to conveyance direction F of paper sheet P, and are coaxially arranged on the same axis. No driving force is transmitted to axis 40c, and driven roller bodies 4LC and 4RC and corrugation roller bodies 4LS and 4RS are driven to rotate by the movement of paper sheet P which is conveyed via driving roller 3.

Corrugation roller 4 is structured such that driven roller body 4LC is arranged to face driving roller body 3LC which is located near left of center in the width direction of paper sheet P, and driven roller body 4RC is arranged to face driving roller body 3RC which is located on near right of center in the width direction of paper sheet P.

Also, corrugation roller 4 is structured such that corrugation roller body 4LS is arranged, to be movable in the axis direction and to face driving roller body 3LS which is located near the left edge side in the width direction of paper sheet P. In a similar fashion, corrugation roller body 4RS is arranged to be movable in the axis direction and to face driving roller body 3RS which is located near the right edge side in the width direction of paper sheet P.

Corrugation roller body 4LS is structured such that nipping section 41 is disposed opposite to driving roller body 3LS, and corrugation imparting section 42 is provided to face the outer side area of driving roller body 3LS. The outer periphery of corrugation imparting section 42 does not face the outer periphery of driving roller body 3LS, and protrudes beyond the outer periphery of driving roller body 3LS on the lateral side thereof in the direction toward the axis of driving roller body 3LS.

Corrugation roller 4 includes spring 48D which biases corrugation roller body 4LS in the direction in which corrugation imparting section 42 approaches driving roller body 3LS. Spring 48D, which constitutes a biasing mechanism, is structured of a coil spring, and is attached in such a mariner that axis 40c is inserted into spring 48D in this example.

Corrugation roller body 4RS has substantially the same constitution as corrugation roller body 4LS, and is structured such that nipping section 41 faces driving roller body 3RS, and corrugation imparting section 42 is provided to face the outer side area of driving roller body 3RS. The outer periphery of corrugation imparting section 42 does not face the outer periphery of driving roller body 3RS, and protrudes beyond the outer periphery of driving roller body 3RS on the lateral side thereof in the direction toward the axis of driving roller body 3RS.

Corrugation roller 4 includes spring 48D which biases corrugation roller body 4LS in the direction in which corrugation imparting section 42 approaches driving roller body 3RS. Spring 48D, which constitutes a biasing mechanism, is structured of a coil spring, and is attached in such a manner that axis 40c is inserted into spring 48D in this example.

Corrugation roller 4 is structured such that interval “a”, in the direction of axis 40c, between corrugation imparting section 42, of corrugation roller body 4LS, and driving roller body 3LS, is adjusted on a relationship between the biasing force of spring 48D and the basis weight of paper sheet P. In a similar fashion, interval “a”, in the direction of axis 40c, between corrugation imparting section 42 of corrugation roller body 4RS and driving roller body 3RS, is adjusted on a relationship between the biasing force of spring 48D and the basis weight of paper sheet P.

On corrugation roller 4, interval “a” is narrow in cases in which the basis weight paper sheet P is the predetermined low basis weight, and interval “a” is wide in cases in which the basis weight paper sheet P is the predetermined standard basis weight. In corrugation roller 4, in cases in which interval “a” becomes narrow, endings along the direction perpendicular to conveyance direction F, become deeper, and therefore, a stronger corrugation is imparted. On the other hand, in cases in which interval “a” becomes wide, curlings along the direction perpendicular to conveyance direction F become shallower, and therefore, a weaker corrugation is imparted.

### [Example of Operation of a Paper Sheet Conveyance Device According to the Fourth Preferred Embodiment]

Next, paper sheet conveyance device 60D, incorporated in image forming apparatus 100, will be described in detail with reference to the drawings.

In the image forming processing, paper sheet P, to be conveyed by being nipped between driving roller 3 and corrugation roller 4, is curved at both the left and right sides of the paper sheet, with respect to conveyance direction F, via corrugation imparting section 42 of corrugation roller bodies 4LS and 4RS, whereby curved portion Pm along conveyance direction F is formed. By curved portion Pm, which is formed along conveyance direction F at both the left and right sides of, the paper sheet, with respect to conveyance direction F, paper sheet P is curved in a direction perpendicular to the conveyance direction F, and corrugation is imparted.

In cases in which the basis weight of paper sheet P is the predetermined low basis weight, interval “a” between corrugation imparting section 42 of corrugation roller body 4LS and driving roller body 3LS does not extend due to the pressing force of spring 48D, and is maintained at a narrow interval, having been set in accordance with the basis weight. In a similar fashion, interval “a” between corrugation imparting section 42 of corrugation roller body 4RS and driving roller body 3RS does not extend due to the pressing force of spring 48D, and is maintained in the narrow interval, having been set in accordance with the basis weight.

In corrugation roller 4, in cases in which interval “a” becomes narrow, curlings along the direction perpendicular to conveyance direction F of paper sheet P, to be nipped between corrugation roller 4 and driving roller 3, become deep, and therefore, a stronger corrugation is imparted.

In such a way, in cases in which the basis weight of paper sheet P is the predetermined low basis weight, because corrugation is imparted, curls on paper sheet P along conveyance direction F, paper sheet P which is to be conveyed to transfer section 24 of image forming section 2, are corrected, and also, stiffness of paper sheet P along conveyance direction F is improved. Because paper sheet P, of which curls have been corrected, and stiffness has also been improved, is conveyed to image forming section 2, conveyance failures and image forming failures, attributable to conveyance failures, are reduced.

In cases in which the basis weight of paper sheet P, to be conveyed, is the predetermined standard basis weight, interval “a” between corrugation imparting section 42 of corrugation roller body 4LS and driving roller body 3LS extends against the pressing force of spring 48D in accordance with the basis weight. In a similar fashion, interval “a” between corrugation imparting section 42 of corrugation roller body 4RS and driving roller body 3RS increases against the pressing force of spring 48D in accordance with the basis weight

In corrugation roller 4, in cases in which interval “a” becomes wide, curlings along the direction perpendicular to conveyance direction F of paper sheet P, to be nipped between corrugation roller 4 and driving roller 3, become shallow, and therefore, a weaker corrugation is imparted.

In cases in which the basis weight of paper sheet P is the predetermined standard basis weight, curling along conveyance direction F is less likely to occur even if corrugation is imparted weakly, or corrugation is not imparted, and also, stiffness of paper sheet P along conveyance direction F is assured. In this way, conveyance problems and image defects, which are attributable to the conveyance problems, are reduced.

Therefore, in cases in which the basis weight of paper sheet P, to be conveyed, is the predetermined standard basis weight, by extending interval “a” between corrugation imparting section 42 and driving roller body 3RS so as to reduce the pressing force of corrugation imparting section 42, streaking on paper sheet P along the conveyance direction, caused by corrugation roller 4, can be prevented.

### [An Example of Structure of a Paper Sheet Conveyance Device According to a Fifth Preferred Embodiment]

FIGS. 14a and 14b are each a front view illustrating an example of a paper sheet conveyance device according to a fifth preferred embodiment. Paper sheet conveyance device 60D, according to the fifth preferred embodiment of paper sheet conveyance device 60, will now be described in detail with reference to the drawings.

Paper sheet conveyance device 60E, which is incorporated in the above-mentioned image forming apparatus 100, consists of conveyance rollers 10, which is consisted of a pair of rollers and is disposed upstream of transfer section 24 of image forming section 2. Conveyance rollers 10, which is disposed upstream and nearest image forming section 2, consists of driving roller 3, which is driven to rotate, and corrugation roller 4, which is disposed facing driving roller 3 and is disposed to be movable in a direction in which corrugation roller 4 separates from driving roller 3, as a driven roller which is rotated by being driven by paper sheet P which is conveyed via driving roller 3.

Driving roller 3, in this example, consists of six driving roller bodies 3LS, 3LM, 3LC, 3RC, 3RM, and 3RS. Driving roller 3 is structured such that driving roller bodies 3LS, 3LM, 3LC, 3RC, 3RM, and 3RS are attached on axis 30, which is perpendicular to conveyance direction F of paper sheet P, and are coaxially arranged on the same axis. Driving force, from a driving means such as a motor or the like, is transmitted to axis 30 via a gear and belt, not illustrated in the figure, and by the driving force transmitted to axis 30, driving roller bodies 3LS, 3LM, 3LC, 3RC, 3RM, and 3RS are driven to rotate.

Corrugation roller 4 consists of two driven roller bodies 4LC and 4RC, and two corrugation roller bodies 4LS and 4RS. Corrugation roller 4 is structured such that driven roller bodies 4LC and 4RC are attached on axis 40a, which is perpendicular to conveyance direction F of paper sheet P.

Also, corrugation roller 4 is structured such that each of corrugation roller bodies 4LS and 4RS, in which each corrugation imparting section 42 protrudes from each outer periphery of nipping section 41, is attached on each axis 40b, which is perpendicular to conveyance direction F of paper sheet P and is independent of axis 40a.

Corrugation roller 4 is structured such that no driving force is transmitted to axis 40a or axes 40b, and driven roller bodies 4LC and 4RC and corrugation roller bodies 4LS and 4RS are driven to rotate via the movement of paper sheet P which is conveyed via driving roller 3.

Corrugation roller 4 is structured such that axis 40b of corrugation roller body 4LS is supported by supporting a first supporting member 43EL, which constitutes a supporting mechanism, and axis 40b of corrugation roller body 4RS is supported by a second supporting member 43ER, which constitutes a supporting mechanism.

The first supporting member 43EL and the second supporting member 43ER are supported to be movable in the direction of the axes of driving roller 3 and corrugation roller 4, and corrugation roller body 4LS and corrugation roller body 4RS are structured to be movable in the direction of axes.

As an example of a constitution in which corrugation roller body 4LS and corrugation roller body 4RS are structured to be movable in the direction of the axes, the construction, in this example, consists of rack gear 49EL provided on the first supporting member 43EL, rack gear 49ER provided on the second supporting member 43ER, and pinion gear 49EP which engages with rack gear 49EL and rack gear 4ER.

Corrugation roller 4 is structured such that corrugation roller body 4LS and corrugation roller body 4RS are moved in the direction in which the interval therebetween increases or decreases, by rotating pinion gear 49EP clockwise or counterclockwise.

Corrugation roller body 4LS moves, in the direction of axes, from a position in which it faces driving roller body 3LM to a position in which it faces driving roller body 3LS, and corrugation roller body 4RS moves, in the direction of axes, from a position in which it faces driving roller body 3RM to a position in which it faces driving roller body 3RS.

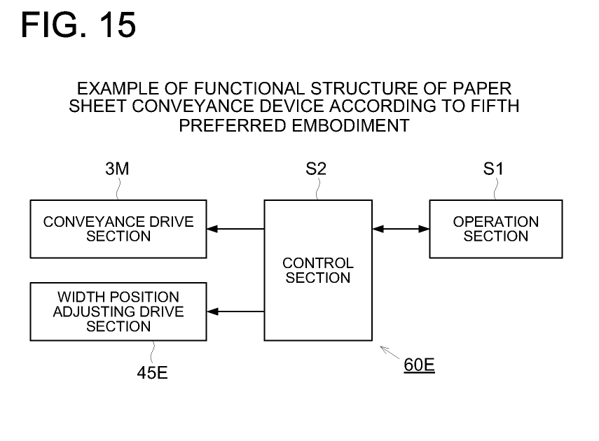

FIG. 15 is a functional block diagram illustrating an example of a control system of the paper sheet conveyance device according to the fifth preferred embodiment. Paper sheet conveyance device 60E consists of conveyance drive section 3M, which is consisted of a motor or the like to drive driving roller 3, and width position adjusting drive section 45E which moves corrugation roller body 4LS and corrugation roller body 4RS in the direction in which the interval therebetween increases or decreases.

Width position adjusting drive section 45E consists of a motor, or the like, which drives pinion gear 49EP, in this example, and drives pinion gear 49EP clockwise or counterclockwise so as to move corrugation roller body 4LS and corrugation roller body 4RS in the direction in which the interval therebetween increases or decreases.

Also, paper sheet conveyance device 60E consists of operation section S1 in which information to set the width of paper sheet P, as an example, paper sheet type information, or the like, is selected, and control section S2, configured to convey paper sheet P by controlling conveyance drive section 3M and to control width position adjusting drive section 45E in accordance with the width information or the like, having been set via operation section S1.

It should be noted that, in the case in which paper sheet conveyance device 60E is incorporated in the above-mentioned image forming apparatus 100, operation section Si and control section S2 is structured of an operation section and a control section of image forming apparatus 100. Also, conveyance drive section 3M is structured of motors, or the like, which drive driving rollers or the like, in paper sheet conveyance system 1 of image forming apparatus 100.

In control section S2, width position adjusting drive section 45E is controlled, in cases in which the width of paper sheet P is narrow, such that corrugation roller body 4LS faces driving roller body 3LM, and corrugation roller body 4RS faces driving roller body 3RM.

Also, in control section S2, width position adjusting drive section 45E is controlled, in cases in which the width of paper sheet P is wide, such that corrugation roller body 4LS faces driving roller body 3LS, and corrugation roller body 4RS faces driving roller body 3RS.

### [Example of Operation of a Paper Sheet Conveyance Device According to the Fifth Preferred Embodiment]

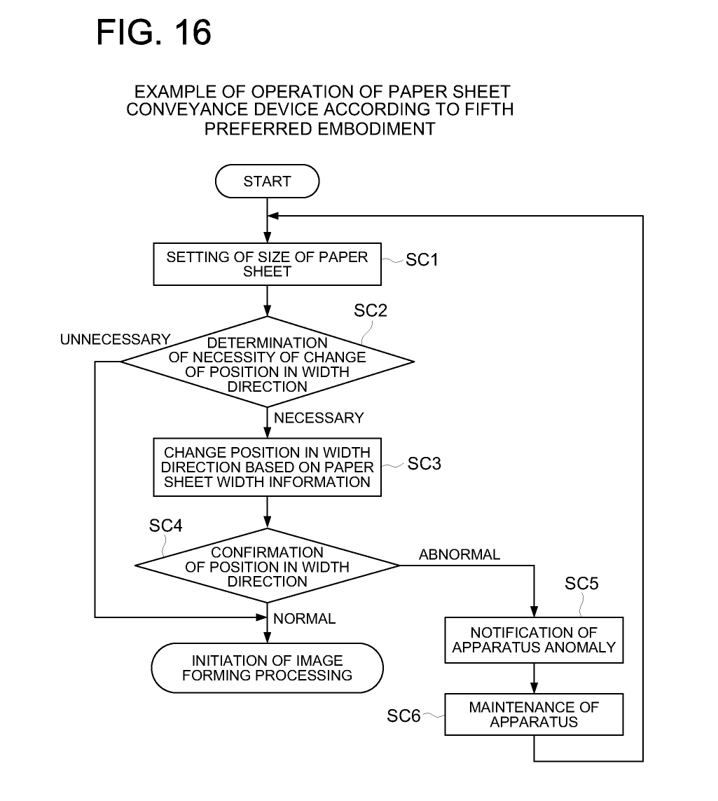

FIG. 16 is a flow chart illustrating an example of an operation of the paper sheet conveyance device according to the fifth preferred embodiment. Next, paper sheet conveyance device 60E, incorporated in image forming apparatus 100, will be described in detail with reference to the drawings.

To begin with, the width of paper sheet P is set in step SC1 in FIG. 16. The width of paper sheet P is set by selecting the type of paper sheet P, or the like, via operation section S1, in conformity with paper sheets P having been stacked on paper sheet trays 50.

Next, in step SC2 in FIG. 16, control section S2 determines whether or not the positions of corrugation roller body 4LS and corrugation roller body 4RS, in the width direction, are to be changed. As an example, in control section S2, the width of paper sheet P, having been set at the time of previous image formation or the like, is memorized, and control section 2 determines whether or not the positions of corrugation roller body 4LS and corrugation roller body 4RS, in the width direction, are to be changed based on whether or not the width of paper sheet P, having been set at this time, is the same as the width of paper sheet P, having been set.

Control section S2 is configured to initiate the image forming processing in cases in which the width of paper sheet P, having been set at the time of previous image formation, or the like, is the same as the width of paper sheet P, having been set at this time, without changing the positions of corrugation roller bodies 4LS and 4RS in the width direction. On the other hand, control section S2 is configured to change the positions of corrugation roller bodies 4LS and 4RS in the width direction, in step SC3 in FIG. 16, in accordance with the width information, in cases in which the width of paper sheet P, having been set at the time of previous image formation, or the like, is not the same as the width of paper sheet P, having been set at this time.

In cases in which the width of paper sheet P, having been set at this time, is less than a predetermined small size, control section S2 controls width position adjusting drive section 45E so that corrugation roller body 4LS faces driving roller body 3LM which is located inside of corrugation roller body 3LS. In a similar fashion, control section S2 controls width position adjusting drive section 45E so that corrugation roller body 4RS faces driving roller body 3RM which is located inside of corrugation roller body 3RS.

In cases in which the width of paper sheet P, having been set at this time, is a large size which is more than or equal to the predetermined small size, control section S2 controls width position adjusting drive section 45E so that corrugation roller body 4LS faces driving roller body 3LS which is located outside of corrugation roller body 3LM. In a similar fashion, control section S2 controls width position adjusting drive section 45E so that corrugation roller body 4RS faces driving roller body 3RS which is located outside of corrugation roller body 3RM.

After control section S2 has carried out the control to change the positions of corrugation roller bodies 4LS and 4RS, in the width direction, in step SC3 in FIG. 16, control section S2 determines, in step SC4, whether or not the change of the positions of corrugation roller bodies 4LS and 4RS, in the width direction, has been completed normally. In this example, control section S2 detects the positions of corrugation roller bodies 4LS and 4RS, in the width direction, based on the detection signal output from a sensor, which is not illustrated in the figure.

In cases in which control section S2 has determined, in step SC4 in FIG. 16, that the change of the positions of corrugation roller bodies 4LS and 4RS, in the width direction, has not been carried out normally, control section S2 notifies, in step SA6, that a failure has occurred in the apparatus by a screen display, or the like, in operation section S1. It should be noted that, in cases in which a service person in charge of maintenance, or the like, has corrected the failure and reset the abnormal signal, which indicates that a failure has occurred in the apparatus, in step SC6, the process flow returns to step SA1, namely, “setting of width of paper sheet P”.

Control section S2 initiates the image forming processing in cases in which control section S2 has determined that the change of the positions of corrugation roller bodies 4LS and 4RS, in the width direction, has been carried out normally.

In the image forming processing, paper sheet P, to be conveyed by being nipped between driving roller 3 and corrugation roller 4, is curved at both the left and right sides of the paper sheet, with respect to conveyance direction F, via corrugation imparting section 42 of corrugation roller bodies 4LS and 4RS, and thereby curved portion Pm along conveyance direction F is formed. By curved portion Pm which is formed along conveyance direction F at both the left and right sides of the paper sheet, with respect to conveyance direction F, paper sheet P is curved in a direction perpendicular to the conveyance direction F, and corrugation is imparted.

In cases in which the width of paper sheet P is less than the predetermined small size, control section S2 controls so that corrugation roller body 4LS faces driving roller body 3LM which is located inside of corrugation roller body 3LS, and that corrugation roller body 4RS faces driving roller body 3RM which is located inside of corrugation roller body 3RS. In such a way, curved portion Pm on paper sheet P of a narrow width is fixated along conveyance direction F at both the left and right sides of the paper sheet, with respect to conveyance direction F, and paper sheet P is curved in a direction perpendicular to the conveyance direction F, and corrugation is imparted.

In cases in which the width of paper sheet P, having been set, is a large size which is more than or equal to the predetermined small size, control section S2 controls so that corrugation roller body 4LS faces driving roller body 3LS which is located outside of corrugation roller body 3LM, and that corrugation roller body 4RS faces driving roller body 3RS which is located outside of corrugation roller body 3RM. In such a way, curved portion Pm on paper sheet P of a narrow width is formed along conveyance direction F at both the left and right sides of the paper sheet, not near the center thereof, with respect to conveyance direction F, and paper sheet P is curved in a direction perpendicular to the conveyance direction F, and corrugation is imparted.

Therefore, curved portion Pm, on paper sheet P of a narrow width, is formed along conveyance direction F at both the left and right sides of the paper sheet, with respect to conveyance direction F, in accordance with the width of paper sheet P, and paper sheet P is curved in a direction perpendicular to the conveyance direction F, and corrugation is imparted.

In this way, curls on paper sheet P along conveyance direction F, paper sheet P which is to be conveyed to transfer section 24 of image forming section 2, are corrected, and also, stiffness of paper sheet P along conveyance direction F is improved. Because paper sheet P, of which curls have been corrected, and stiffness has also been improved, is conveyed to image forming section 2, conveyance failures and image forming failures attributable to conveyance failures are reduced.

Also, in cases in which the operation to adjust the positions of corrugation roller bodies 4LS and 4RS in the width direction, has not been completed normally, by carrying out the above-mentioned error handling procedure, it can eliminate the possibility that corrugation roller bodies 4LS and 4RS do not come into contact with paper sheet P, and corrugation is not imparted. Also, in cases in which the width of paper sheet P is wide, it can eliminate the possibility that corrugation roller bodies 4LS and 4RS come into contact with paper sheet P near the center of paper sheet P, and corrugation is imparted. In such a way, conveyance failures and image forming failures attributable to conveyance failures are reduced.

Although the preferred embodiment of the present invention have been fully described by way of examples with reference to the accompanying drawings, it is to be noted that various changes and modifications will be apparent to those skilled in the art. Therefore, unless such changes and modifications depart from the scope of the present invention, they are to be construed as being included therein.

1-12. (canceled)

13. A paper sheet conveyance device for conveying a paper sheet to an image forming section of an image forming apparatus comprising:
a driving roller comprising a plurality of driving roller bodies provided upstream of the image forming section with respect to a conveyance direction of the paper sheet; and
a driven roller comprising a driven roller body and two corrugation roller bodies provided so that each of the driven roller and the two corrugation roller bodies faces each of the plurality of driving roller bodies so as to convey the paper sheet by nipping the paper sheet between the driving roller body and the driven roller body, and between the driving roller bodies and the two corrugation roller bodies,
wherein each of the corrugation roller bodies are provided at positions corresponding to both side portions of the paper sheet with respect to the conveyance direction and the driven roller body is provided at a position between the two corrugation roller bodies,
wherein each of the two corrugation roller bodies comprises nipping section which holds the paper sheet between it and the driving roller body and corrugation imparting section protruding from an outer periphery of the nipping section and the corrugation imparting section is structured so as to have a larger diameter than that of the nipping section,
wherein the corrugation roller imparting section imparts corrugation at end portions of the both sides of the paper sheet; and
wherein said corrugation roller bodies are supported to be movable along an axis direction of said corrugation roller bodies while each of said corrugation imparting section is biased via a biasing member in a direction in which said corrugation imparting section approaches said driven roller body.

14. The paper sheet conveyance device of claim 1, wherein a distance between the corrugation roller bodies and said image forming section is configured to be a shorter distance than a minimum length of paper sheet that can be passed so that when a leading edge of a paper sheet having the minimum length of paper sheet reaches the image forming section, a trailing edge of the paper sheet having the minimum length of paper sheet is nipped between the driving roller bodies and the corrugation roller bodies.

15. An image forming apparatus comprising:
an image forming section for forming an image; and
a sheet conveyance device for conveying a paper sheet to the image forming section, the sheet conveyance device comprising:
a driving roller comprising a plurality of driving roller bodies provided upstream of the image forming section with respect to a conveyance direction of the paper sheet; and
a driven roller comprising a driven roller body and two corrugation roller bodies provided so that each of the driven roller and the two corrugation roller bodies faces each of the plurality of driving roller bodies so as to convey the paper sheet by nipping the paper sheet between the driving roller body and the driven roller body, and between the driving roller bodies and the two corrugation roller bodies,
wherein each of the corrugation roller bodies are provided at positions corresponding to both side portions of the paper sheet with respect to the conveyance direction and the driven roller body is provided at a position between the two corrugation roller bodies,
wherein each of the two corrugation roller bodies comprises nipping section which holds the paper sheet between it and the driving roller body and corrugation imparting section protruding from an outer periphery of the nipping section and the corrugation imparting section is structured so as to have a larger diameter than that of the nipping section,
wherein the corrugation roller imparting section imparts corrugation at end portions of the both sides of the paper sheet; and
wherein said corrugation roller bodies are supported to be movable along an axis direction of said corrugation roller bodies while each of said corrugation imparting section is biased via a biasing member in a direction in which said corrugation imparting section approaches said driven roller body.

16. The image forming apparatus of claim 3, wherein a distance between the corrugation roller bodies and said image forming section is configured to be a shorter distance than a minimum length of paper sheet that can be passed so that when a leading edge of a paper sheet having the minimum length of paper sheet reaches the image forming section, a trailing edge of the paper sheet having the minimum length of paper sheet is nipped between the driving roller bodies and the corrugation roller bodies.
